(19) United States
(12) Patent Application Publication
(10) Pub. No.: US 2016/0070394 A1
(43) Pub. Date: Mar. 10, 2016

(54) BEZEL CIRCUIT

(71) Applicant: Uni-Pixel Displays, Inc., The Woodlands, TX (US)

(72) Inventors: Daniel Van Ostrand, Conroe, TX (US); Kenny Huy Pham, Spring, TX (US)

(21) Appl. No.: 14/481,589

(22) Filed: Sep. 9, 2014

(51) Int. Cl. G06F 3/047; G06F 3/044; G06F 3/045; G09G 5/00

(52) U.S. Cl. CPC G06F 3/047; G09G 5/003; G06F 3/044; G06F 3/045; G09G 2300/04

(57) ABSTRACT

A method of designing a bezel circuit includes identifying a plurality of channels in a representation of a conductive pattern. For each channel, a representation of a channel connector is placed that connects to the channel outside a viewable area of the conductive pattern. An interface location outside the viewable area of the conductive pattern is identified. For each channel, a representation of an interface connector within the interface location is placed and a representation of an interconnect route that connects its placed interface connector to its corresponding placed channel connector is placed with at least a minimum interconnect route-to-interconnect route spacing. The at least one interconnect route expands into available space within a bezel area as the interconnect route routes from the interface connector toward the channel connector while maintaining the at least minimum interconnect route-to-interconnect route spacing.

### BACKGROUND OF THE INVENTION

A touch screen enabled system allows a user to control various aspects of the system by touch or gestures on the screen. For example, a user may interact directly with one or more objects depicted on a display device by touch or gestures that are sensed by a touch sensor. The touch sensor typically includes a conductive pattern disposed on a substrate configured to sense touch. Touch screens are commonly used in consumer, commercial, and industrial systems.

### BRIEF SUMMARY OF THE INVENTION

According to one aspect of one or more embodiments of the present invention, a method of designing a bezel circuit includes identifying a plurality of channels in a representation of a conductive pattern. For each channel, a representation of a channel connector is placed that connects to the channel outside a viewable area of the conductive pattern. An interface location outside the viewable area of the conductive pattern is identified. For each channel, a representation of an interface connector within the interface location is placed and a representation of an interconnect route that connects its placed interface connector to its corresponding placed channel connector is placed with at least a minimum interconnect route-to-interconnect route spacing. The at least one interconnect route expands into available space within a bezel area as the interconnect route routes from the interface connector toward the channel connector while maintaining the at least minimum interconnect route-to-interconnect route spacing.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled computing system in accordance with one or more embodiments of the present invention.

FIG. 3 shows a functional representation of a touch sensor as part of a touch screen in accordance with one or more embodiments of the present invention.

FIG. 4 shows a cross-section of a touch sensor with conductive patterns disposed on opposing sides of a transparent substrate in accordance with one or more embodiments of the present invention.

FIG. 5 shows a first conductive pattern disposed on a transparent substrate in accordance with one or more embodiments of the present invention.

FIG. 6 shows a second conductive pattern disposed on a transparent substrate in accordance with one or more embodiments of the present invention.

FIG. 7 shows a portion of a touch sensor in accordance with one or more embodiments of the present invention.

FIG. 8A shows an overview of a touch sensor with conventional bezel circuits in accordance with one or more embodiments of the present invention.

FIG. 8B shows zoomed in views of the touch sensor with conventional bezel circuit of FIG. 8A in accordance with one or more embodiments of the present invention.

FIG. 9 shows an overview of a touch sensor and touch sensor bezel circuits in accordance with one or more embodiments of the present invention.

FIG. 10A shows an overview of a touch sensor bezel circuit for a first conductive pattern with column channels in accordance with one or more embodiments of the present invention.

FIG. 10B shows a zoomed in view of a portion of the touch sensor bezel circuit for the first conductive pattern with column channels of FIG. 10A in accordance with one or more embodiments of the present invention.

FIG. 10C shows a zoomed in view of a portion of the touch sensor bezel circuit for the first conductive pattern with column channels of FIG. 10A in accordance with one or more embodiments of the present invention.

FIG. 10D shows a zoomed in view of a portion of the touch sensor bezel circuit for the first conductive pattern with column channels of FIG. 10A in accordance with one or more embodiments of the present invention.

FIG. 10E shows a zoomed in view of a portion of the touch sensor bezel circuit for the first conductive pattern with column channels of FIG. 10A in accordance with one or more embodiments of the present invention.

FIG. 10F shows a zoomed in view of a portion of the touch sensor bezel circuit for the first conductive pattern with column channels of FIG. 10A in accordance with one or more embodiments of the present invention.

FIG. 10G shows a zoomed in view of a portion of the touch sensor bezel circuit for the first conductive pattern with column channels of FIG. 10A in accordance with one or more embodiments of the present invention.

FIG. 11A shows an overview of a touch sensor bezel circuit for a second conductive pattern with row channels in accordance with one or more embodiments of the present invention.

FIG. 11B shows a zoomed in view of a portion of the touch sensor bezel circuit for the second conductive pattern with row channels of FIG. 11A in accordance with one or more embodiments of the present invention.

FIG. 11C shows a zoomed in view of a portion of the touch sensor bezel circuit for the second conductive pattern with row channels of FIG. 11A in accordance with one or more embodiments of the present invention.

FIG. 11D shows a zoomed in view of a portion of the touch sensor bezel circuit for the second conductive pattern with row channels of FIG. 11A in accordance with one or more embodiments of the present invention.

FIG. 11E shows a zoomed in view of a portion of the touch sensor bezel circuit for the second conductive pattern with row channels of FIG. 11A in accordance with one or more embodiments of the present invention.

FIG. 12 shows different fill patterns for an interconnect route in accordance with one or more embodiments of the present invention.

FIG. 13 shows a method of routing a touch sensor bezel circuit in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

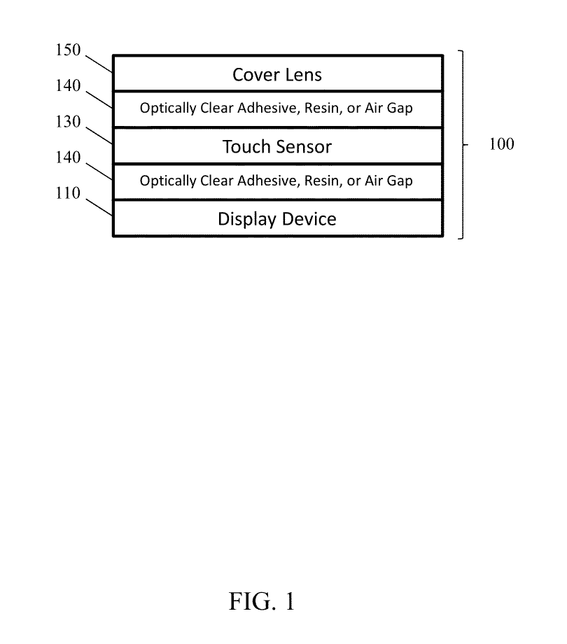

FIG. 1 shows a cross-section of a touch screen 100 in accordance with one or more embodiments of the present invention. Touch screen 100 includes a display device 110. Display device 110 may be a Liquid Crystal Display (“LCD”), Light-Emitting Diode (“LED”), Organic Light-Emitting Diode (“OLED”), Active Matrix Organic Light-Emitting Diode (“AMOLED”), In-Plane Switching (“IPS”), or other type of display device suitable for use as part of a touch screen application or design. In one or more embodiments of the present invention, touch screen 100 may include a touch sensor 130 that overlays at least a portion of a viewable area of display device 110. The viewable area of display device 110 includes the area defined by the light emitting pixels (not shown) of the display device 110 that are typically viewable to an end user under a cover lens 150. In certain embodiments, an optically clear adhesive or resin 140 may bond a bottom side of touch sensor 130 to a top, or user-facing, side of display device 110. In other embodiments, an isolation layer, or air gap, 140 may separate the bottom side of touch sensor 130 from the top, or user-facing, side of display device 110. Cover lens 150 may overlay a top, or user-facing, side of touch sensor 130. Cover lens 150 may be composed of glass, plastic, film, or other material. In certain embodiments, an optically clear adhesive or resin 140 may bond a bottom side of cover lens 150 to the top, or user-facing, side of touch sensor 130. In other embodiments, an isolation layer, or air gap, 140 may separate the bottom side of cover lens 150 and the top, or user-facing, side of touch sensor 130. A top side of cover lens 150 faces the user and protects the underlying components of touch screen 100. In one or more embodiments of the present invention, touch sensor 130, or the function or functions that it implements, may be integrated into the display device 110 itself (not independently illustrated). One of ordinary skill in the art will recognize that touch sensor 130 may be a capacitive, resistive, optical, acoustic, or any other type of touch sensor capable of sensing touch.

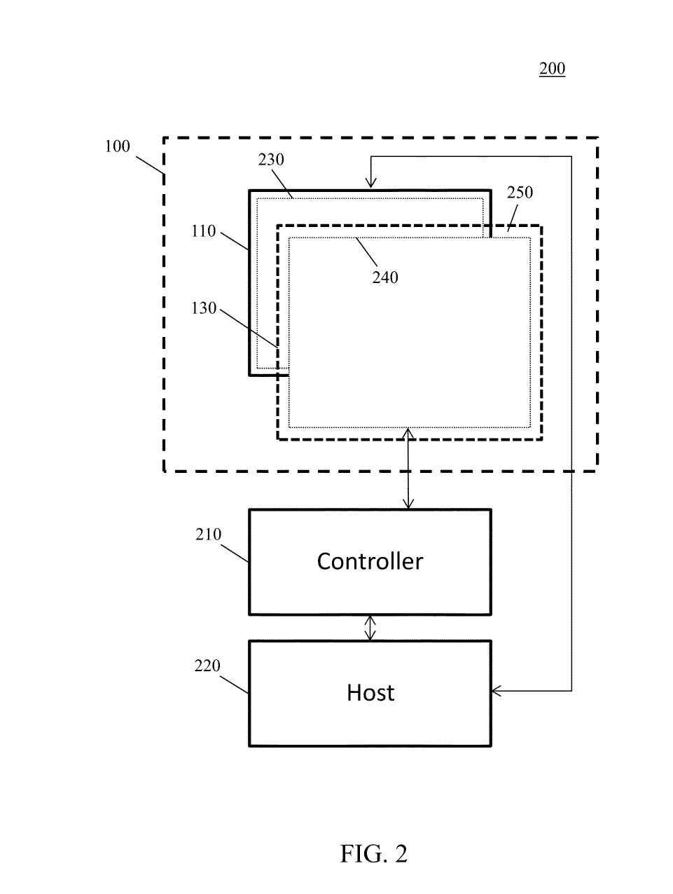

FIG. 2 shows a schematic view of a touch screen enabled computing system 200 in accordance with one or more embodiments of the present invention. Computing system 200 may be a consumer computing system, commercial computing system, or industrial computing system including, but not limited to, a smartphone, a tablet computer, a laptop computer, a desktop computer, a printer, a monitor, a television, an appliance, a kiosk console, an automatic teller machine, a copier, a desktop phone, an automotive display system, a portable gaming device, a gaming console, or any other system suitable for use with touch screen 100. Computing system 200 may include one or more printed or flex circuits (not shown) on which one or more processors (not shown) and system memory (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). Computing system 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including a network-attached storage device and a cloud-based storage device.

In certain embodiments, touch screen 100 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110. Touch sensor 130 may include a bezel area 250 outside at least one side of the viewable area 240 that provides connectivity between touch sensor 130 and a controller 210. In other embodiments, touch sensor 130, or the function or functions that it implements, may be integrated into display device 110 itself (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210. In typical applications, the manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with computing system 200 by touch or gestures on touch screen 100. In certain embodiments, host 220 may be the one or more printed or flex circuits (not shown) on which the one or more processors (not shown) are disposed. In other embodiments, host 220 may be a subsystem or any other part of computing system 200 that is configured to interface with display device 110 and controller 210.

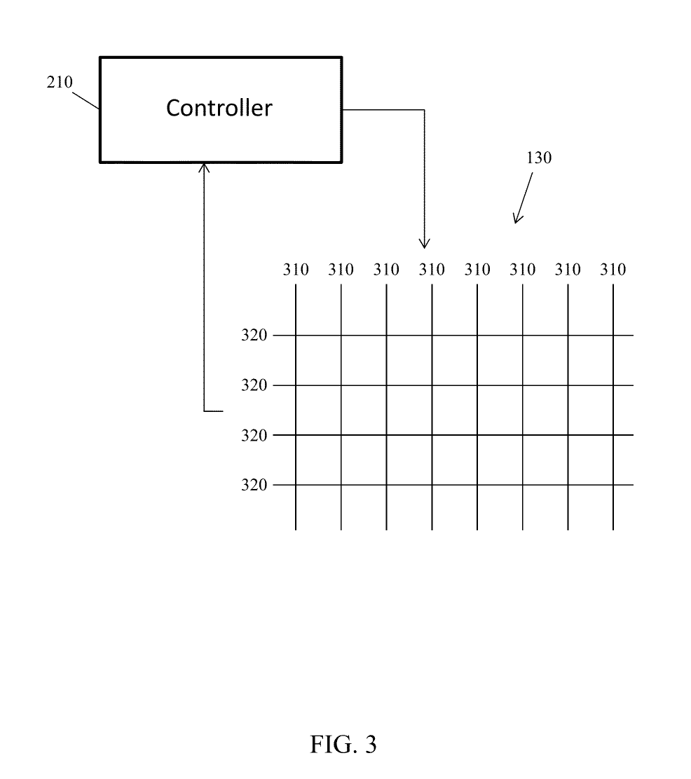

FIG. 3 shows a functional representation of a touch sensor 130 as part of a touch screen 100 in accordance with one or more embodiments of the present invention. In certain embodiments, touch sensor 130 may be viewed as a plurality of column channels 310 and a plurality of row channels 320 arranged as a mesh grid. The number of column channels 310 and the number of row channels 320 may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by measuring, for example, capacitance at each intersection. This process may be continued through all row channels 320 (or all column channels 310) such that capacitance is measured at each uniquely addressable location of touch sensor 130 at predetermined intervals. Controller 210 may allow for the adjustment of the scan rate depending on the needs of a particular application or design. One of ordinary skill in the art will recognize that the scanning process discussed above may also be used with other touch sensor technologies in accordance with one or more embodiments of the present invention. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

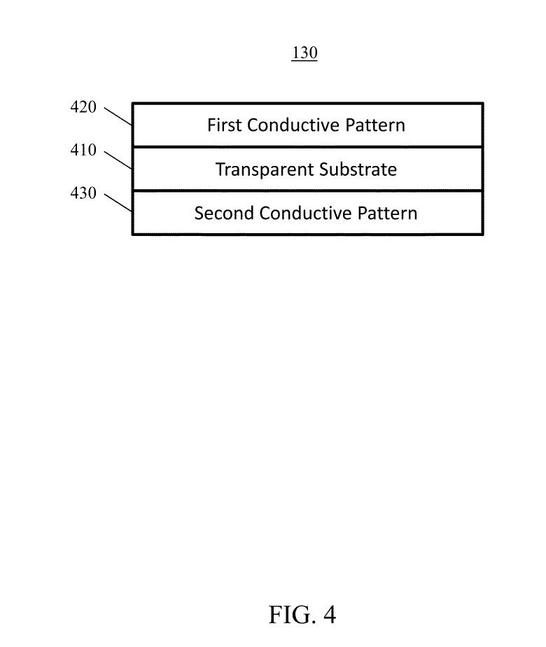

FIG. 4 shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 may overlay the second conductive pattern 430 at a predetermined alignment that may include an offset. One of ordinary skill in the art will recognize that a conductive pattern may be any shape or pattern of one or more conductors (not shown) in accordance with one or more embodiments of the present invention. One of ordinary skill in the art will also recognize that any type of touch sensor 130 conductor, including, for example, metal conductors, metal mesh conductors, indium tin oxide (“ITO”) conductors, poly(3,4-ethylenedioxythiophene (“PEDOT”) conductors, carbon nanotube conductors, silver nanowire conductors, or any other touch sensor 130 conductors may be used in accordance with one or more embodiments of the present invention.

One of ordinary skill in the art will recognize that any touch sensor 130 stackup that includes one or more connections between one or more conductors of the touch sensor 130 and one or more off substrate 410 connections, circuits, or devices (not shown) may be used in accordance with one or more embodiments of the present invention. For example, single-sided touch sensor 130 stackups may include conductors disposed on a single side of a substrate 410 where conductors that cross are isolated from one another by a dielectric material (not shown), such as, for example, as used in On Glass Solution (“OGS”) touch sensor 130 embodiments. Double-sided touch sensor 130 stackups may include conductors disposed on opposing sides of the same substrate 140 (as shown in FIG. 4) or bonded touch sensor 130 embodiments where conductors are disposed on at least two different sides of at least two different substrates 410. Bonded touch sensor 130 stackups may include, for example, two single-sided substrates 410 bonded together, one double-sided substrate 410 bonded to a single-sided substrate 410, or a double-sided substrate 410 bonded to another double-sided substrate 410. One of ordinary skill in the art will recognize that other touch sensor 130 stackups, including those that vary in the number, type, or organization of substrate(s) and/or conductive pattern(s) are within the scope of one or more embodiments of the present invention. One of ordinary skill in the art will also recognize that one or more of the above-noted embodiments may be used in applications or designs where touch sensor 130 is integrated into display device 110 in accordance with one or more embodiments of the present invention.

A conductive pattern (e.g., first conductive pattern 420 or second conductive pattern 430) may be disposed on one or more transparent substrates 410 by any process suitable for disposing conductive lines or features on a substrate. Suitable processes may include, for example, printing processes, vacuum-based deposition processes, solution coating processes, or cure and etch processes that either form conductive lines or features on substrate or form seed lines or features on substrate that may be further processed to form conductive lines or features on substrate. Printing processes may include flexographic printing of catalytic seed lines or features on substrate that are metallized by one or more of an electroless plating process or an immersion plating process, direct flexographic printing of a conductive ink or material on substrate, gravure printing, inkjet printing, rotary printing, or stamp printing. Deposition processes may include pattern-based deposition, chemical vapor deposition, electro deposition, epitaxy, physical vapor deposition, or casting. Cure and etch processes may include optical or UV-based photolithography, e-beam/ion-beam lithography, x-ray lithography, interference lithography, scanning probe lithography, imprint lithography, or magneto lithography. One of ordinary skill in the art will recognize that any process or combination of processes suitable for disposing conductive lines or features on substrate may be used in accordance with one or more embodiments of the present invention.

With respect to transparent substrate 410, transparent means capable of transmitting a substantial portion of visible light through the substrate. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

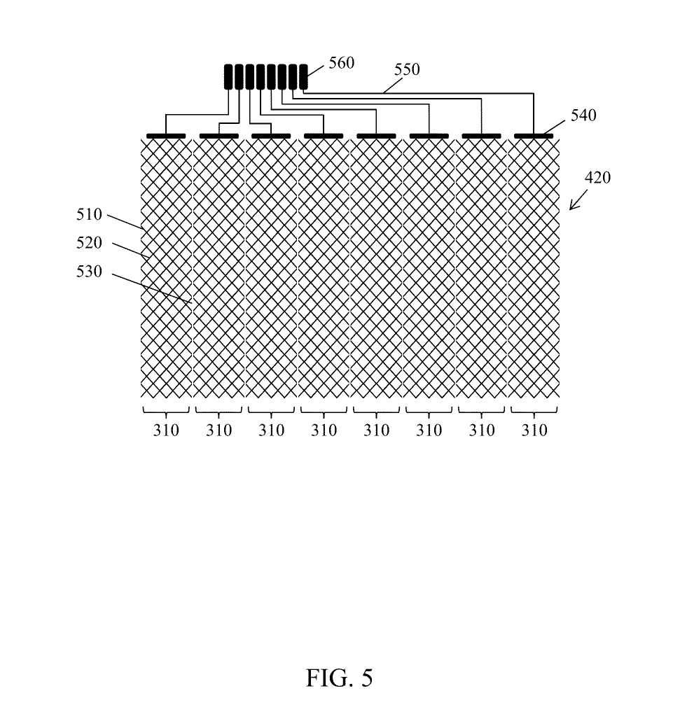

FIG. 5 shows a first conductive pattern 420 disposed on a transparent substrate (e.g., transparent substrate 410) in accordance with one or more embodiments of the present invention. In certain embodiments, first conductive pattern 420 may include a mesh formed by a plurality of parallel conductive lines oriented in a first direction 510 and a plurality of parallel conductive lines oriented in a second direction 520 that are disposed on a side of a transparent substrate (e.g., transparent substrate 410). One of ordinary skill in the art will recognize that the number of parallel conductive lines oriented in the first direction 510 and/or the number of parallel conductive lines oriented in the second direction 520 may vary based on an application or design. One of ordinary skill in the art will also recognize that a size of first conductive pattern 420 may vary based on an application or a design. In other embodiments, first conductive pattern 420 may include any other shape or pattern formed by one or more conductive lines or features (not independently illustrated). One of ordinary skill in the art will recognize that a conductive pattern is not limited to parallel conductive lines and may comprise any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled (not shown) relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention.

In certain embodiments, a plurality of channel breaks 530 may partition first conductive pattern 420 into a plurality of column channels 310, each electrically isolated from the others. One of ordinary skill in the art will recognize that the number of channel breaks 530 and/or the number of column channels 310 may vary based on an application or design in accordance with one or more embodiments of the present invention. Each column channel 310 may route to a channel connector 540. Each channel connector 540 may be substantially rectangular in shape. Each channel connector 540 may have a length that is less than or equal to a width of the corresponding channel it is connected to. Each channel connector 540 may route to an interface connector 560 by way of one or more interconnect conductive lines 550. Interface connectors 560 may provide a connection interface between a touch sensor (e.g., 130 of FIG. 1) and a controller (e.g., 210 of FIG. 2).

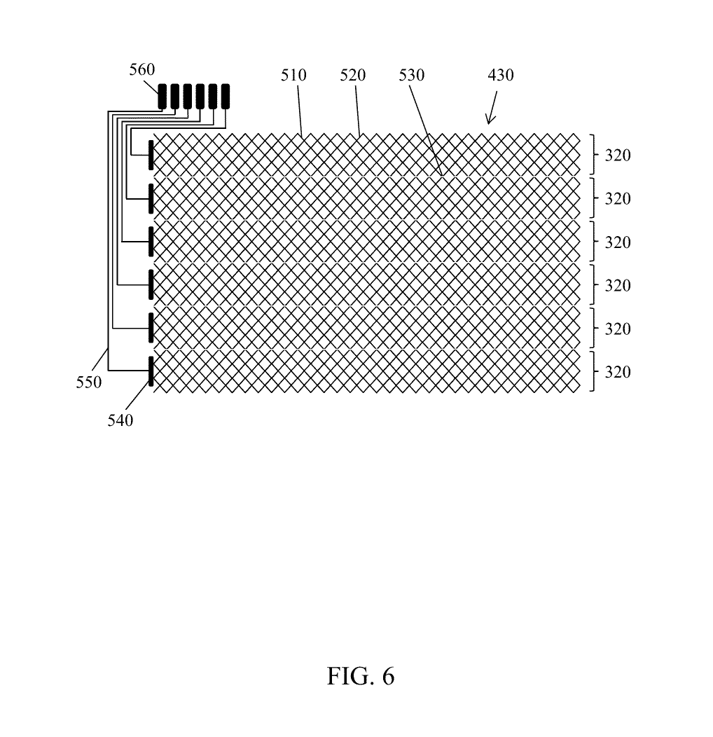

FIG. 6 shows a second conductive pattern 430 disposed on a transparent substrate (e.g., transparent substrate 410) in accordance with one or more embodiments of the present invention. In certain embodiments, second conductive pattern 430 may include a mesh formed by a plurality of parallel conductive lines oriented in a first direction 510 and a plurality of parallel conductive lines oriented in a second direction 520 that are disposed on a side of a transparent substrate (e.g., transparent substrate 410). One of ordinary skill in the art will recognize that the number of parallel conductive lines oriented in the first direction 510 and/or the number of parallel conductive lines oriented in the second direction 520 may vary based on an application or design. The second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern formed by one or more conductive lines or features (not independently illustrated). One of ordinary skill in the art will also recognize that a conductive pattern is not limited to parallel conductive lines and could be any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention.

In certain embodiments, a plurality of channel breaks 530 may partition second conductive pattern 430 into a plurality of row channels 320, each electrically isolated from the others. One of ordinary skill in the art will recognize that the number of channel breaks 530 and/or the number of row channels 320 may vary based on an application or design in accordance with one or more embodiments of the present invention. Each row channel 320 may route to a channel connector 540. Each channel connector 540 may be substantially rectangular in shape. Each channel connector 540 may have a length that is less than or equal to a width of the corresponding channel it is connected to. Each channel connector 540 may route to an interface connector 560 by way of one or more interconnect conductive lines 550. Interface connectors 560 may provide a connection interface between a touch sensor (e.g., 130 of FIG. 1) and a controller (e.g., 210 of FIG. 2).

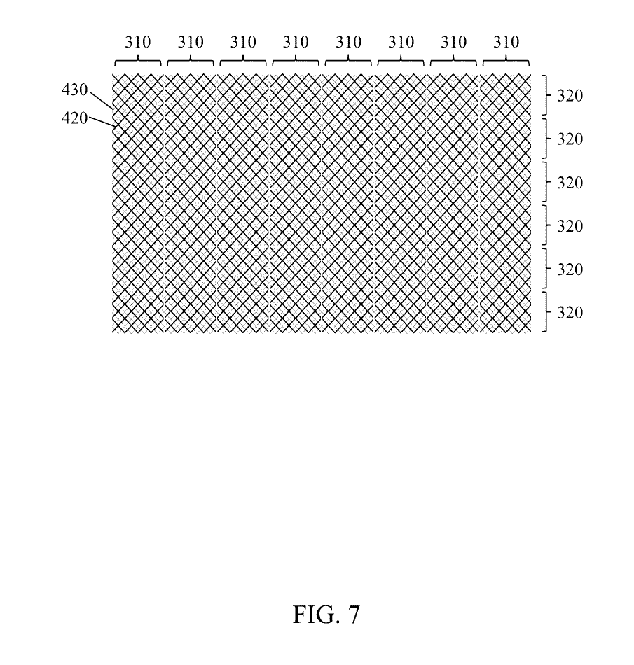

FIG. 7 shows a portion of a touch sensor (e.g., touch sensor 130) in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate. In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 application or design in accordance with one or more embodiments of the present invention. The first conductive pattern 420 and the second conductive pattern 430 may be offset vertically, horizontally, and/or angularly relative to one another. The offset between the first conductive pattern 420 and the second conductive pattern 430 may vary based on an application or a design.

In certain embodiments, the first conductive pattern 420 may include a plurality of parallel conductive lines oriented in a first direction (e.g., 510 of FIG. 5) and a plurality of parallel conductive lines oriented in a second direction (e.g., 520 of FIG. 5) that form a mesh in this instance. The first conductive pattern 420 may be partitioned by a plurality of channel breaks (e.g., 530 of FIG. 5) into electrically isolated column channels 310. In certain embodiments, the second conductive pattern 430 may include a plurality of parallel conductive lines oriented in a first direction (e.g., 510 of FIG. 6) and a plurality of parallel conductive lines oriented in a second direction (e.g., 520 of FIG. 6) that form a mesh in this instance. The second conductive pattern 420 may be partitioned by a plurality of channel breaks (e.g., 530 of FIG. 6) into electrically isolated row channels 320. In operation, a controller (e.g., 210 of FIG. 2) may electrically drive one or more row channels 320 (or column channels 310) and touch sensor 130 senses touch on one or more column channels 310 (or row channels 320) sampled by the controller. In other embodiments, the disposition and/or the role of the first conductive pattern 420 and the second conductive pattern 430 may be reversed.

In certain embodiments, one or more of the plurality of parallel conductive lines oriented in a first direction (e.g., 510 of FIG. 5 or FIG. 6), one or more of the plurality of parallel conductive lines oriented in a second direction (e.g., 520 of FIG. 5 or FIG. 6), one or more of the plurality of channel breaks (e.g., 530 of FIG. 5 or FIG. 6), one or more of the plurality of channel connectors (e.g., 540 of FIG. 5 or FIG. 6), one or more of the plurality of interconnect conductive lines (e.g., 550 of FIG. 5 or FIG. 6), and/or one or more of the plurality of interface connectors (e.g., 560 of FIG. 5 or FIG. 6) of the first conductive pattern 420 and/or the second conductive pattern 430 may have different line widths, orientations, and/or feature sizes. Each may vary in one or more of line width, orientation, and/or feature size. In certain embodiments, the plurality of parallel conductive lines oriented in the first direction (e.g., 510 of FIG. 5 or FIG. 6) may have approximately the same line width and the plurality of parallel lines oriented in the second direction (e.g., 520 of FIG. 5 or FIG. 6) may have approximately the same line width. In addition, the number of parallel conductive lines oriented in the first direction (e.g., 510 of FIG. 5 or FIG. 6), the number of parallel conductive lines oriented in the second direction (e.g., 520 of FIG. 5 or FIG. 6), and the line-to-line spacing between them may vary based on an application or a design. One of ordinary skill in the art will recognize that the size, configuration, and design of each conductive pattern may vary based on an application or a design in accordance with one or more embodiments of the present invention.

In certain embodiments, one or more of the plurality of parallel conductive lines oriented in the first direction (e.g., 510 of FIG. 5 or FIG. 6) and one or more of the plurality of parallel conductive lines oriented in the second direction (e.g., 520 of FIG. 5 or FIG. 6) may have a line width that varies based on an application or design, including, for example, micrometer-fine line widths. One of ordinary skill in the art will recognize that the shape and width of one or more of the plurality of parallel conductive lines oriented in the first direction (e.g., 510 of FIG. 5 or FIG. 6) and one or more of the plurality of parallel conductive lines oriented in the second direction (e.g., 520 of FIG. 5 or FIG. 6) may vary based on an application or a design in accordance with one or more embodiments of the present invention.

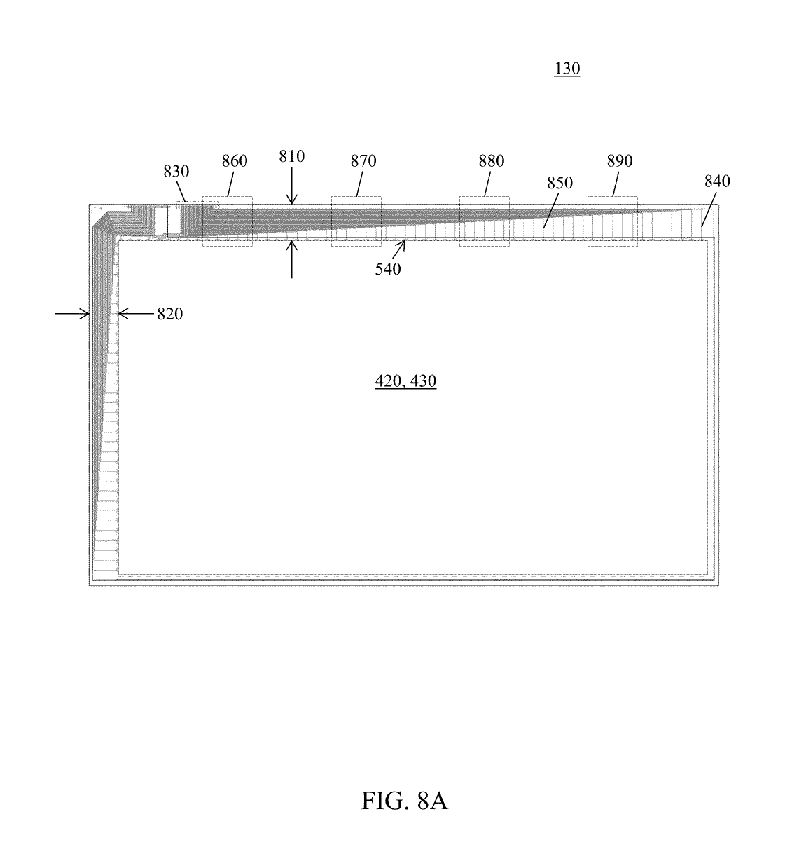

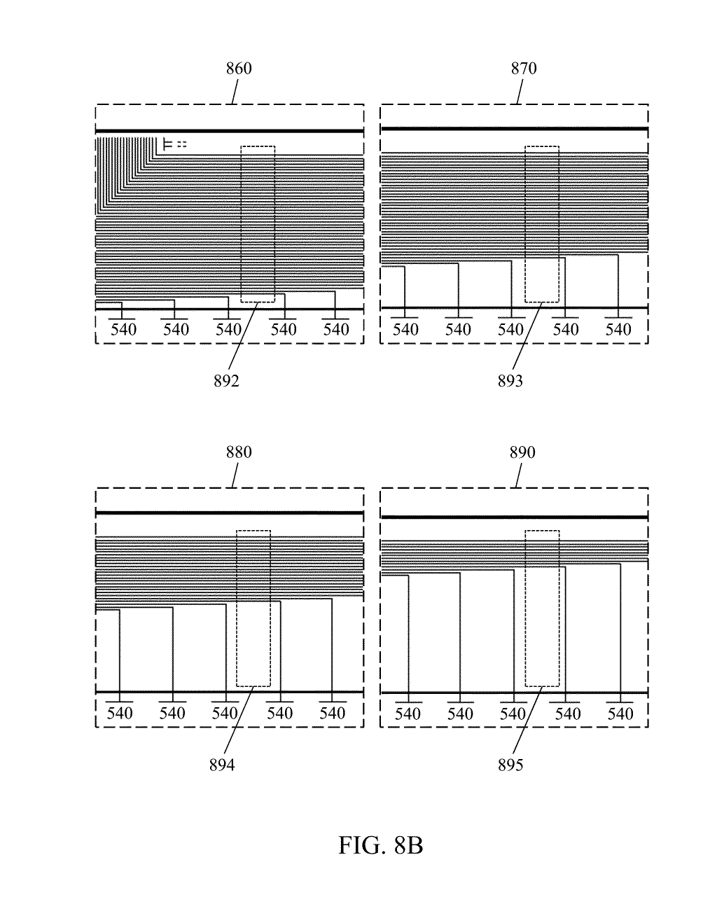

FIG. 8A shows an overview of a touch sensor 130 with conventional bezel circuits 810, 820 in accordance with one or more embodiments of the present invention. Touch sensor 130 may include a first conductive pattern 420 (not independently illustrated) disposed on a side of a first transparent substrate (e.g., transparent substrate 410) and a second conductive pattern 430 (not independently illustrated) disposed on an opposing side of the first transparent substrate or disposed on a side of a second transparent substrate (e.g., transparent substrate 410) that is bonded to the first transparent substrate.

The first conductive pattern 420 may be partitioned into a plurality of column channels (e.g., column channels 310), not independently illustrated. An interface location 830, outside a viewable area of the conductive pattern, may include a plurality of interface connectors (e.g., interface connectors 560) that provide connectivity between the plurality of column channels of the first conductive pattern 420 and a touch sensor controller (e.g., controller 210) via, for example, a cable (not shown). The interface location may be dictated by the constraints of a particular application or design. A plurality of interconnect conductive lines (e.g., interconnect conductive lines 550) connect the plurality of interface connectors to a plurality of channel connectors 540 that are themselves connected to the plurality of column channels of the first conductive pattern 420. While not discussed herein, a conventional bezel circuit 820 may similarly provide connectivity between a plurality of row channels (e.g., row channels 320) of the second conductive pattern 430 and the touch sensor controller.

Conventional bezel circuit 810 may include all conductors and/or circuit elements disposed outside a viewable area of the first conductive pattern 420, but within a bezel area. The bezel area (not independently illustrated) may be bounded in at least one direction by the interface connectors. Given the interface location, the breakout, the number of line segments, and the length of each interconnect conductive line may vary from line to line. The breakout may include, for example, the manner in which a given interconnect conductive line breaks out from a dense area (e.g., the interface location) in order to route to a destination. For example, interconnect conductive line 840 is longer than interconnect conductive line 850. Consequently, interconnect conductive line 840 may be more resistive, more capacitive, and/or may have a longer flight time (from an electrical signaling perspective) than that of interconnect conductive line 850. In conventional bezel circuits, because of the differences in the trace lengths of the interconnect conductive lines, counter measures may be necessary to ensure proper operation of the touch sensor. For example, the trace lengths may be equalized using serpentine traces (not shown), other electrical compensation may be provided (not shown), or compensation may be programmed into a touch sensor controller that allows for such compensation.

FIG. 8B shows zoomed in views of the touch sensor 130 with conventional bezel circuit 810 of FIG. 8A in accordance with one or more embodiments of the present invention. In zoomed in view 860, which is the zoomed in view closest to interface location 830, a group 892 of interconnect conductive lines break to the right as they route from their respective interface connectors to their respective channel connectors 540. The group 892 of interconnect conductive lines may be routed in close proximity with a fixed line-to-line spacing that may be smaller than or equal to the line width. The trace width may be dictated by the desired impedance of a given application or design and the fixed line-to-line spacing may be selected to reduce or eliminate noise, crosstalk, electromagnetic radiation, inter-symbol interference, and/or other undesirable electrical signaling characteristics. In zoomed in view 870, which is the zoomed in view further to the right of zoomed in view 860, some of the interconnect conductive lines from the group 892 of interconnect conductive lines have routed off to their respective channel connectors 540. As such, a group 893 of interconnect conductive lines corresponds to a subset of the group 894 of interconnect conductive lines that continue toward their respective channel connectors 540.

In zoomed in view 880, which is the zoomed in view further to the right of zoomed in view 870, some of the interconnect conductive lines from the group 893 of interconnect conductive lines have routed off to their respective channel connectors 540. As such, a group 894 of interconnect conductive lines corresponds to a subset of the group 893 of interconnect conductive lines that continue toward their respective channel connectors 540. In zoomed in view 890, which is the zoomed in view further to the right of zoomed in view 880, some of the interconnect conductive lines from the group 894 of interconnect conductive lines have routed off to their respective channel connectors 540. As such, a group 895 of interconnect conductive lines corresponds to a subset of the group 894 of interconnect conductive lines that continue toward their respective channel connectors 540. As shown in FIG. 8A and the zoomed in views of FIG. 8B, the interconnect conductive lines are routed as conventional linear traces with fixed trace width and fixed line-to-line spacing. Consequently, the interconnect conductive lines have different trace lengths and may vary in resistance, capacitance, and/or flight times from line to line.

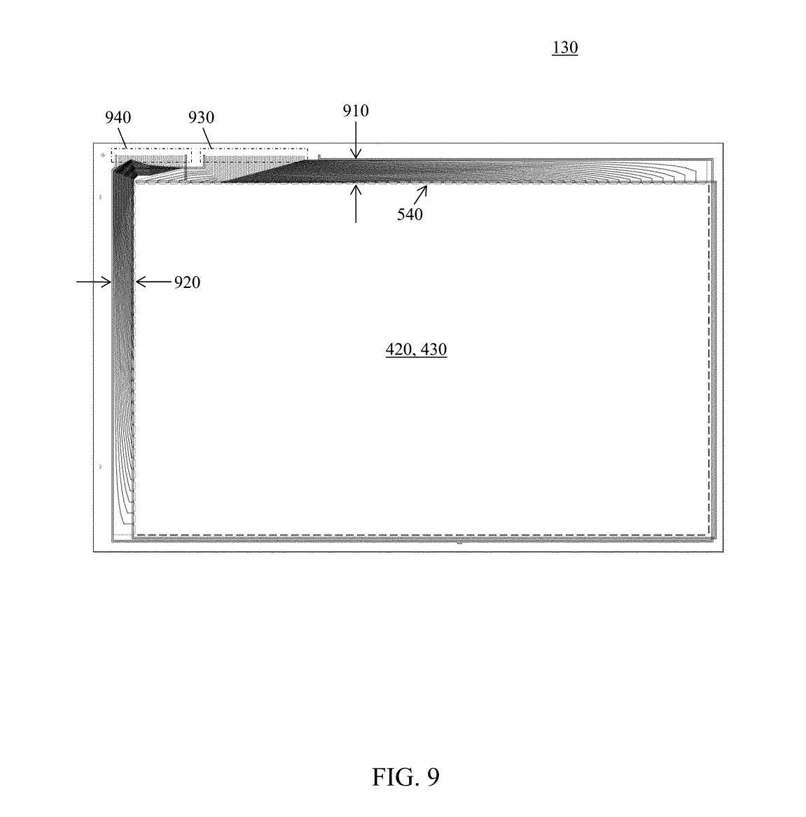

FIG. 9 shows an overview of a touch sensor 130 and touch sensor bezel circuits 910, 920 in accordance with one or more embodiments of the present invention. Touch sensor 130 may include a first conductive pattern 420 (not independently illustrated) disposed on a side of a first transparent substrate (e.g., transparent substrate 410) and a second conductive pattern 430 (not independently illustrated) disposed on an opposing side of the first transparent substrate or disposed on a side of a second transparent substrate (e.g., transparent substrate 410) that is bonded to the first transparent substrate.

The first conductive pattern 420 may be partitioned into a plurality of column channels (e.g., column channels 310), not independently illustrated. A first interface location 930, outside a viewable area of the first conductive pattern 420, may include a plurality of interface connectors (e.g., interface connectors 560) that provide connectivity between the plurality of column channels of the first conductive pattern 420 and a touch sensor controller (e.g., controller 210) via, for example, a cable (not shown). The first interface location may be dictated by the constraints of a particular application or design. A plurality of interconnect routes (not independently illustrated) connect the plurality of interface connectors to a plurality of channel connectors 540 that are themselves connected to the plurality of column channels of the first conductive pattern 420. The viewable area of the first conductive pattern 420 includes that portion of the first conductive pattern 420 that overlays a display device (e.g., display device 100) and transmits the underlying image of the display device to the end user. The viewable area does not include the channel connectors or those portions of the first conductive pattern 420 that are in direct contact with the channel connectors.

The second conductive pattern 430 may be partitioned into a plurality of row channels (e.g., row channels 320), not independently illustrated. A second interface location 940, outside a viewable area of the second conductive pattern 430, may include a plurality of interface connectors that provide connectivity between the plurality of row channels of the second conductive pattern 430 and the touch sensor controller via, for example, a cable. The second interface location may be dictated by the constraints of a particular application or design. A plurality of interconnect routes (not independently illustrated) connect the plurality of interface connectors to a plurality of channel connectors 540 that are themselves connected to the plurality of row channels of the second conductive pattern 430. The viewable area of the second conductive pattern 430 includes that portion of the second conductive pattern 430 that overlays the display device and transmits the underlying image of the display device to the end user. The viewable area does not include the channel connectors or those portions of the first conductive pattern 420 that are in direct contact with the channel connectors.

In certain embodiments, the first interface location 930 and the second interface location 940 may be disposed outside the viewable areas of their respective conductive patterns on a same axis of touch sensor 130. In other embodiments, the first interface location 930 and the second interface location 940 may be disposed outside the viewable areas of their respective conductive patterns on different axes of touch sensor 130 (not shown). One of ordinary skill in the art will recognize that the first interface location 930 and the second interface location 940 may vary based on an application or design in accordance with one or more embodiments of the present invention. One of ordinary skill in the art will also recognize that the first interface location 930 and the second interface location 940 may be constrained by other aspects of an application or design including, for example, a location of an antenna (not shown), a design constraint relating to cabling (not shown), or a physical constraint of a touch screen or computing system (e.g., computing system 200) in which it is disposed (not shown).

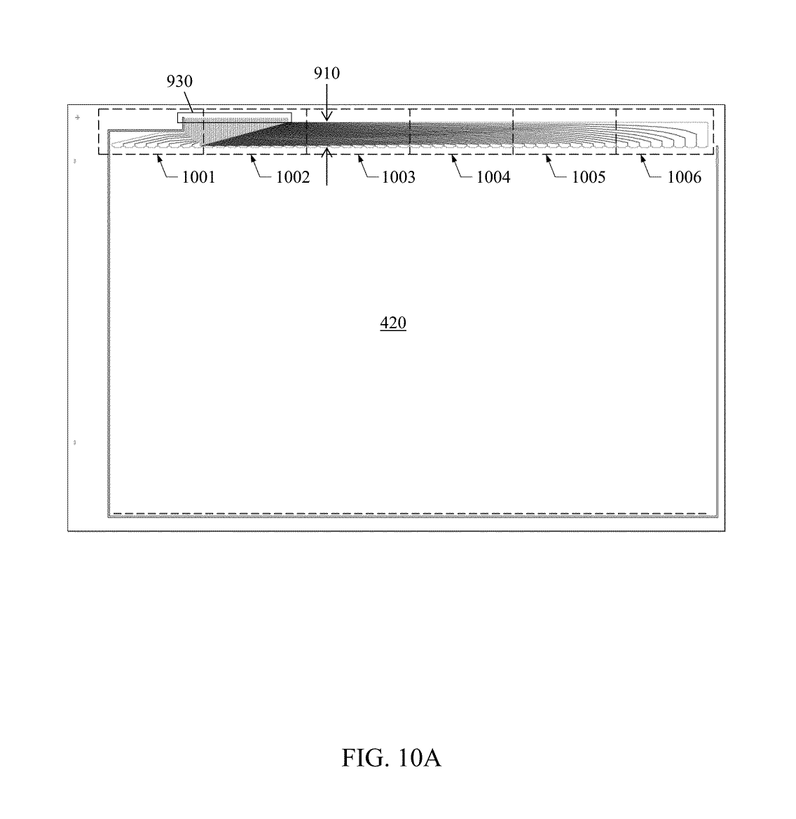

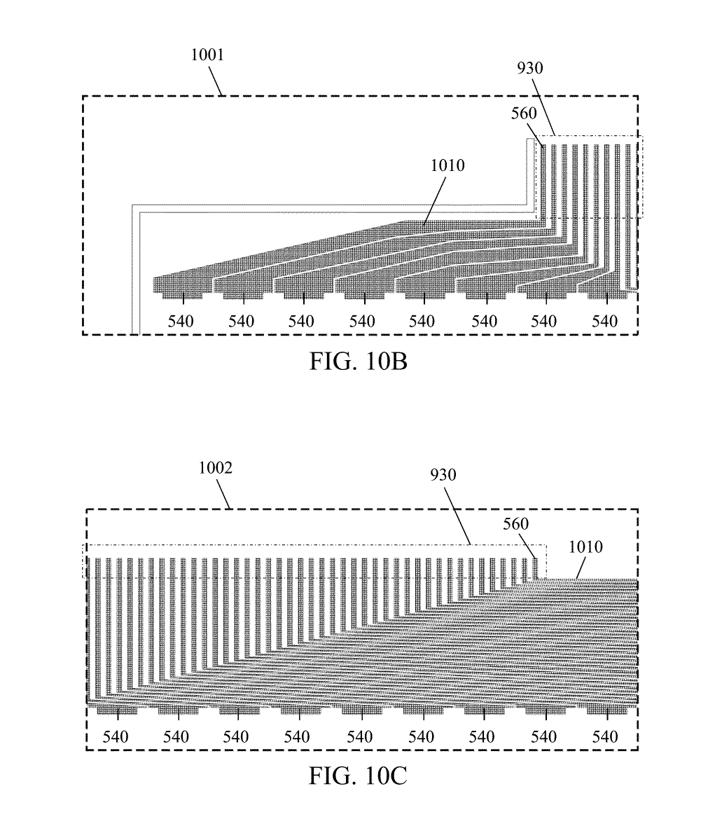

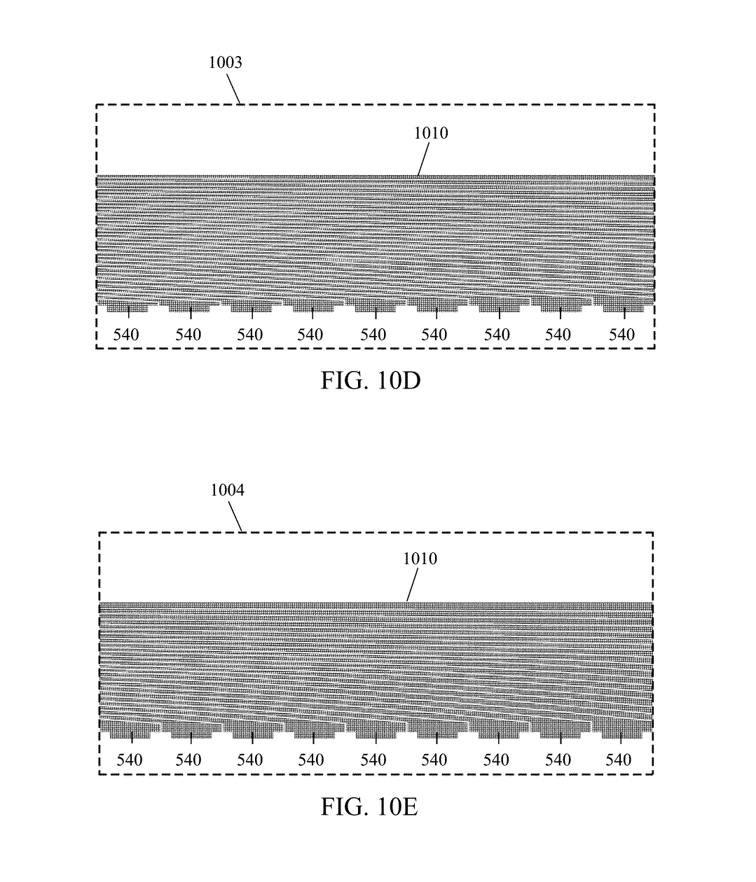

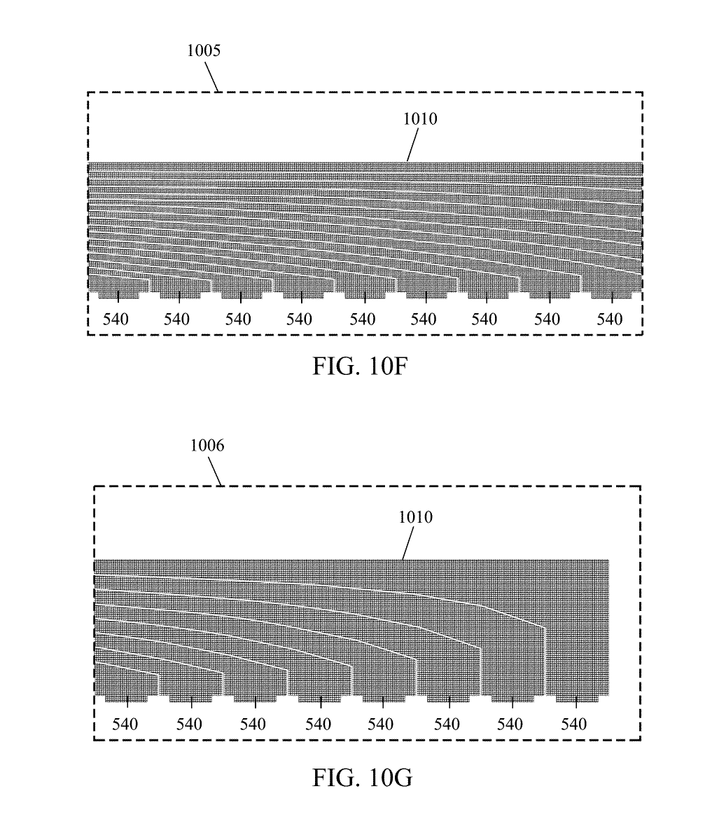

FIG. 10A shows an overview of touch sensor bezel circuit 910 for a first conductive pattern 420 with column channels (e.g., column channels 310), not independently illustrated, in accordance with one or more embodiments of the present invention.

Continuing in FIG. 10B, a zoomed in view of a portion 1001 of bezel circuit 910 is shown in accordance with one or more embodiments of the present invention. Portion 1001 is the leftmost portion of bezel circuit 910 of FIG. 10A. A plurality of interconnect routes 1010 route away from their respective interface connectors 560 towards their respective channel connectors 540 (only one route 1010 is labeled with a reference numeral so as to not obscure the drawing). The interconnect routes 1010 may be non-linear, non-uniform, and unique in shape. The interconnect routes 1010 may be spaced out from one another with at least a minimum interconnect route-to-interconnect route spacing. In certain embodiments, the interconnect route-to-interconnect route spacing may be in a range between approximately 5 micrometers and approximately 100 micrometers. In other embodiments, the interconnect route-to-interconnect route spacing may be in a range between approximately 40 micrometers and approximately 60 micrometers. One of ordinary skill in the art will recognize that other interconnect route-to-interconnect route spacings may be used in accordance with one or more embodiments of the present invention. One of ordinary skill in the art will also recognize that the interconnect route-to-interconnect route spacing may vary based on an application or design.

In certain embodiments, at least one interconnect route 1010 expands into available space within a bezel area as interconnect route 1010 routes away from interface connector 560 towards channel connector 540 while maintaining the at least minimum interconnect route-to-interconnect route spacing. In other embodiments, a plurality of interconnect routes 1010 expand into available space, evenly or otherwise, while maintaining the at least minimum interconnect route-to-interconnect route spacing for a portion of their routes from their respective interface connectors 560 towards their respective channel connectors 540. In this way, the interconnect routes 1010 may have a shape and a width that varies based on the constraints within the bezel area for a given location including the number of interconnect routes 1010 in that location. Nearest to the first interface location 930, the density of interconnect routes 1010 is high. However, as the interconnect routes break away from the first interface location 930, they expand into the available space within the bezel area subject to the constraint that all interconnect routes 1010 must connect their respective interface connectors 560 to their respective channel connectors 540 and at least the minimum interconnect route-to-interconnect route spacing must be maintained. As such, in high density locations, the interconnect routes 1010 may be somewhat uniform in shape and width. However, as interconnect routes 1010 route off to their respective channel connectors, more space becomes available and the remaining interconnect routes 1010 continue towards their respective channel connectors and expand into the newly available space. This available width of the interconnect routes 1010 in these areas reduce the overall resistance of the conductive pathway and help reduce variation of resistance between the shortest and the longest interconnect routes 1010.

Continuing in FIG. 10C, a zoomed in view of a portion 1002 of bezel circuit 910 is shown in accordance with one or more embodiments of the present invention. Portion 1002 is to the right of leftmost portion 1001 of bezel circuit 910 of FIG. 10A. In portion 1002, a large number of interconnect routes 1010 are broken out from their respective interface connectors 560. Because of their density, taking up all of the bezel area in this location, the interconnect routes 1010 are somewhat uniform in shape and width for a portion of their routes. However, as interconnect routes 1010 route off to their respective channel connectors 540, more space becomes available and the remaining interconnect routes 1010, that have not yet routed to their respective channel connectors, may expand into the newly available space. As such, the interconnect routes remain non-linear, non-uniform, and unique in shape.

Continuing in FIG. 10D, a zoomed in view of a portion 1003 of bezel circuit 910 is shown in accordance with one or more embodiments of the present invention. Portion 1003 is to the right of portion 1002 of bezel circuit 910 of FIG. 10A. In portion 1003, the remaining interconnect routes 1010 continue to expand into the available space as other interconnect routes 1010 route off to their respective channel connectors 540.

Continuing in FIG. 10E, a zoomed in view of a portion 1004 of bezel circuit 910 is shown in accordance with one or more embodiments of the present invention. Portion 1004 is to the right of portion 1003 of bezel circuit 910 of FIG. 10A. In portion 1004, the remaining interconnect routes 1010 continue to expand into the available space as other interconnect routes 1010 route off to their respective channel connectors 540.

Continuing in FIG. 10F, a zoomed in view of a portion 1005 of bezel circuit 910 is shown in accordance with one or more embodiments of the present invention. Portion 1005 is to the right of portion 1004 of bezel circuit 910 of FIG. 10A. In portion 1005, the remaining interconnect routes 1010 continue to expand into the available space as other interconnect routes 1010 route off to their respective channel connectors 540. As the density decrease, the expansion is more readily discernible.

Continuing in FIG. 10G, a zoomed in view of a portion 1006 of bezel circuit 910 is shown in accordance with one or more embodiments of the present invention. Portion 1006 is to the right of portion 1005 of bezel circuit 910 of FIG. 10A. In portion 1006, the remaining interconnect routes 1010 continue to expand into the available space as other interconnects routes 1010 route off to their respective channel connectors 540. As shown in the FIGS. 10A through 10G, longer interconnect routes 1010 have more surface area than shorter interconnect routes. This increased surface area may compensate for increased resistance, and/or flight times occasioned by the excess length.

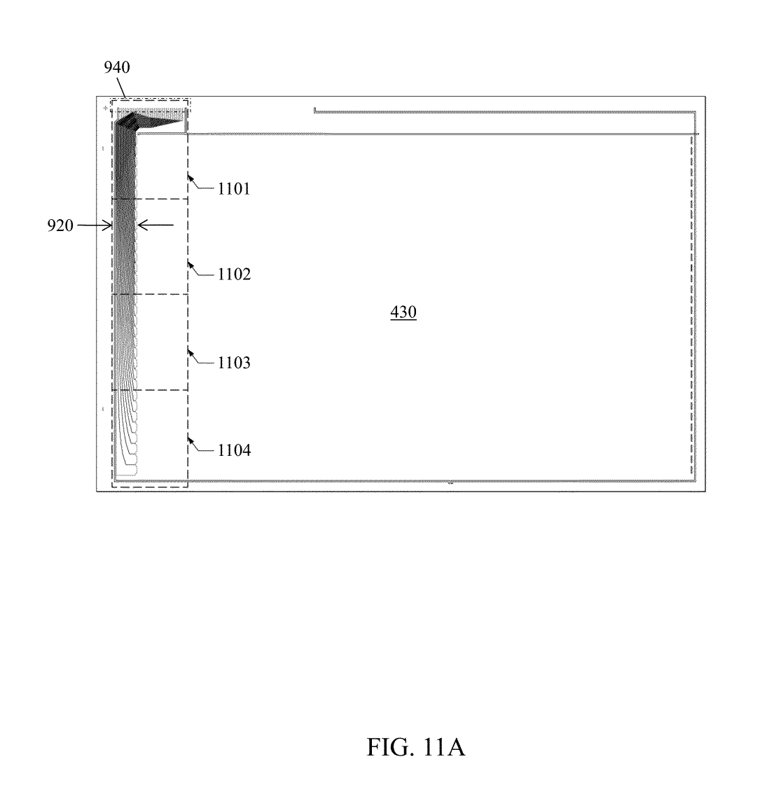

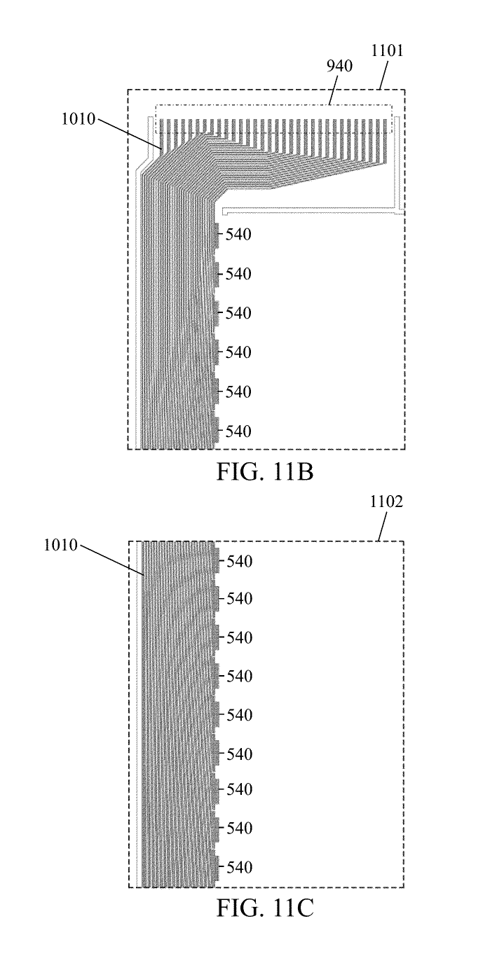

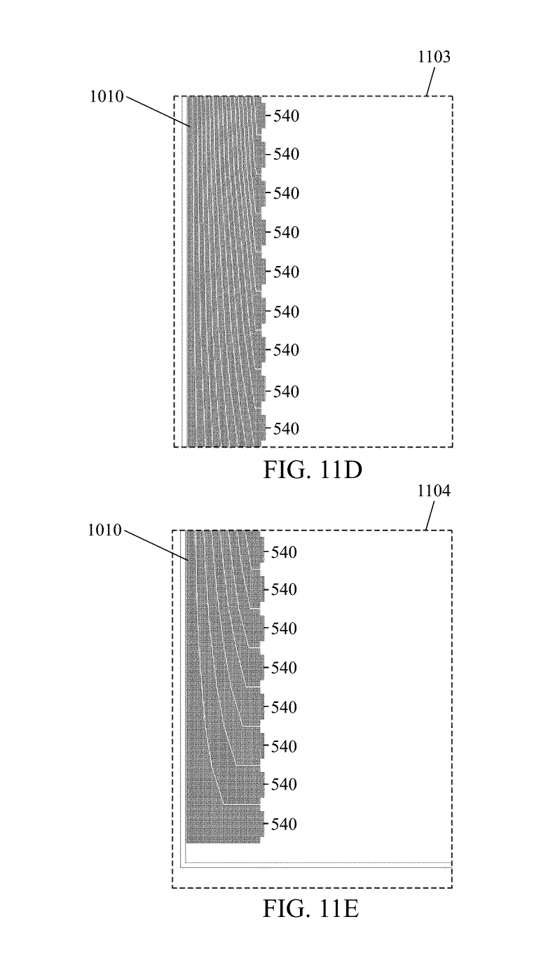

FIG. 11A shows an overview of touch sensor bezel circuit 920 for a second conductive pattern 430 with row channels (e.g., row channels 320), not independently illustrated, in accordance with one or more embodiments of the present invention.

Continuing in FIG. 11B, a zoomed in view of a portion 1101 of bezel circuit 920 is shown in accordance with one or more embodiments of the present invention. Portion 1101 is the topmost portion of bezel circuit 920 of FIG. 11A. A plurality of interconnect routes 1010 route away from their respective interface connectors 560 towards their respective channel connectors 540 (only one route 1010 is labeled with a reference numeral so as to not obscure the drawing). The interconnect routes 1010 may be non-linear, non-uniform, and unique in shape. The interconnect routes 1010 may be spaced out from one another with at least a minimum interconnect route-to-interconnect route spacing. In certain embodiments, the interconnect route-to-interconnect route spacing may be in a range between approximately 5 micrometers and approximately 100 micrometers. In other embodiments, the interconnect route-to-interconnect route spacing may be in a range between approximately 40 micrometers and approximately 60 micrometers. One of ordinary skill in the art will recognize that other interconnect route-to-interconnect route spacings may be used in accordance with one or more embodiments of the present invention. One of ordinary skill in the art will also recognize that the interconnect route-to-interconnect route spacing may vary based on an application or design.

In certain embodiments, at least one interconnect route 1010 expands into available space within a bezel area as interconnect route 1010 routes away from interface connector 560 towards channel connector 540 while maintaining the at least minimum interconnect route-to-interconnect route spacing. In other embodiments, a plurality of interconnect routes 1010 expand into available space, evenly or otherwise, while maintaining the at least minimum interconnect route-to-interconnect route spacing for a portion of their routes from their respective interface connectors 560 towards their respective channel connectors 540. In this way, the interconnect routes 1010 may have a shape and a width that varies based on the constraints within the bezel area for a given location including the number of interconnect routes 1010 in that location. Nearest to the second interface location 940, the density of interconnect routes 1010 is high. However, as the interconnect routes break away from the second interface location 940, they expand into the available space within the bezel area subject to the constraint that all interconnect routes 1010 must connect their respective interface connectors 560 to their respective channel connectors 540 and at least the minimum interconnect route-to-interconnect route spacing must be maintained. As such, in high density locations, the interconnect routes 1010 may be somewhat uniform in shape and width. However, as interconnect routes 1010 route off to their respective channel connectors, more space becomes available and the remaining interconnect routes 1010 continue towards their respective channel connectors and expand into the newly available space.

Continuing in FIG. 11C, a zoomed in view of a portion 1102 of bezel circuit 920 is shown in accordance with one or more embodiments of the present invention. Portion 1102 is below portion 1101 of bezel circuit 920 of FIG. 11A. In portion 1102, the remaining interconnect routes 1010 continue to expand into the available space as other interconnect routes 1010 route off to their respective channel connectors 540.

Continuing in FIG. 11D, a zoomed in view of a portion 1103 of bezel circuit 920 is shown in accordance with one or more embodiments of the present invention. Portion 1103 is below portion 1102 of bezel circuit 920 of FIG. 11A. In portion 1103, the remaining interconnect routes 1010 continue to expand into the available space as other interconnect routes 1010 route off to their respective channel connectors 540. As the density decrease, the expansion is more readily discernible.

Continuing in FIG. 11E, a zoomed in view of a portion 1104 of bezel circuit 920 is shown in accordance with one or more embodiments of the present invention. Portion 1104 is below portion 1103 of bezel circuit 920 of FIG. 11A. In portion 1104, the remaining interconnect routes 1010 continue to expand into the available space as other interconnects routes 1010 route off to their respective channel connectors 540. As shown in the FIGS. 11A through 11E, longer interconnect routes 1010 have more surface area than shorter interconnect routes. This increased surface area may compensate for increased resistance, and/or flight times occasioned by the excess length.

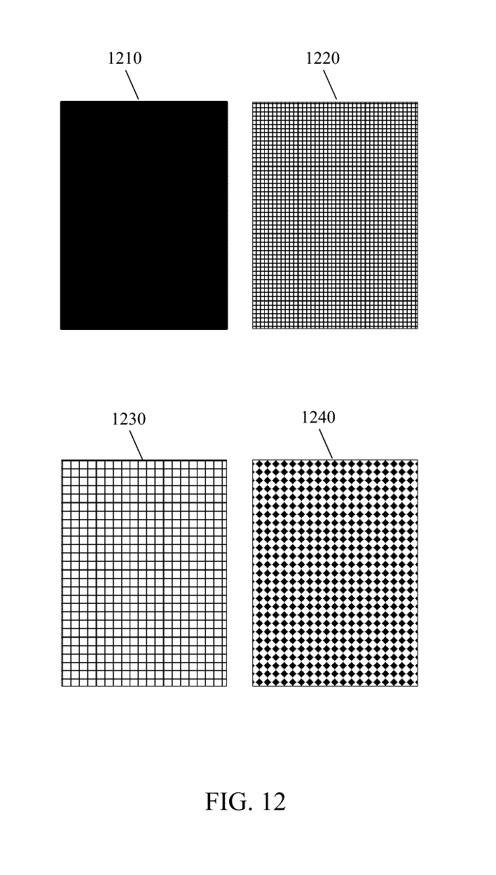

FIG. 12 shows different fill patterns for an interconnect route 1010 in accordance with one or more embodiments of the present invention. The interconnect routes (e.g., interconnect routes 1010 of FIGS. 10 and 11) may be filled with different fill patterns. In certain embodiments, a solid fill pattern 1210 may be used to fill one or more of the interconnect routes. Solid fill pattern 1210 provides the most surface area coverage and the least resistance. However, solid fill pattern 1210 may require more metal or metals and the material and fabrication cost may increase. In other embodiments, a dense cross-hatched fill pattern 1220 may be used to fill one or more of the interconnect routes. Dense cross-hatched fill pattern 1220 may provide substantial surface area coverage and reduce resistance. In addition, dense cross-hatched fill pattern 1220 improves reliability because, if any one or more of the hatching lines be damaged, the remaining hatching lines provide connectivity. In still other embodiments, a less dense cross-hatched fill pattern 1230 may be used to fill one or more of the interconnect routes. Less dense cross-hatched fill pattern 1230 may provide substantial surface area coverage and reduce resistance. In addition, less dense cross-hatched fill pattern 1230 improves reliability because of the redundancy provided by the cross-hatching. However, as the density of the cross-hatched fill pattern decreases, resistance may increase and the reliability may decrease as compared to more dense cross-hatched fill patterns. In embodiments using cross-hatched fill patterns, the cross-hatched interconnect route 1010 may provide lower capacitance than a solid filled interconnect route 1010 of the same shape and size.

In still other embodiments, a hatched polygon fill pattern 1240 may include any polygon pattern, repeating or random, within the fill pattern that provides substantial surface area coverage and reduces resistance. Similar to the other fill patterns, the use of hatched polygon fill pattern 1240 may improve reliability because of the redundancy provided by the hatched polygon fill pattern 1240.

One of ordinary skill in the art will also recognize that other fill patterns may be used in accordance with one or more embodiments of the present invention. One of ordinary skill in the art will also recognize that a type of fill pattern used may vary based on an application or design in accordance with one or more embodiments of the present invention. One of ordinary skill in the art will recognize that one or more different type of fill patterns may be used within the same touch sensor in accordance with one or more embodiments of the present invention.

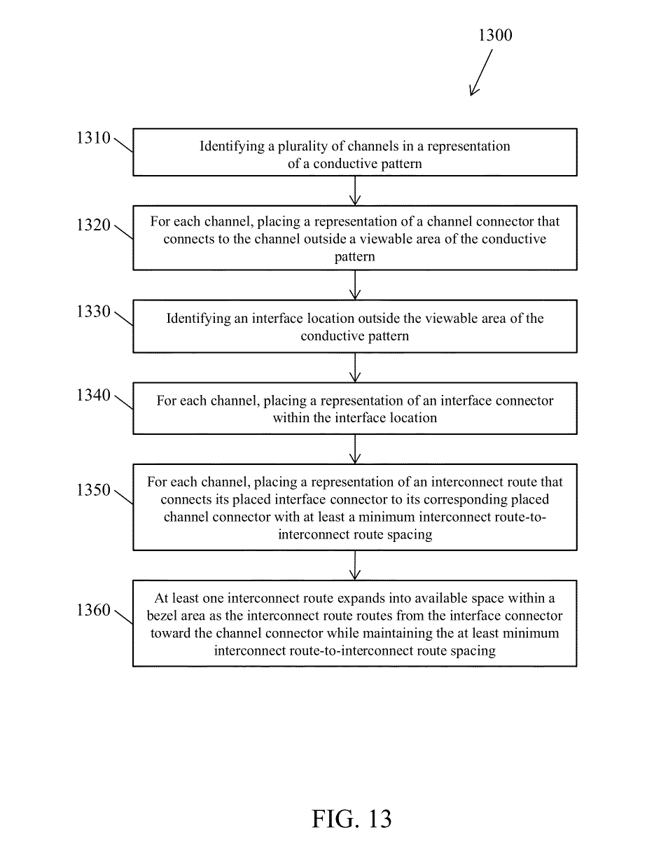

FIG. 13 shows a method 1300 of designing a bezel circuit in accordance with one or more embodiments of the present invention. A computer-aided drafting (“CAD”) software application may be used to design one or more conductive patterns and their respective bezel circuits for use as part of, for example, a touch sensor application. Subsequent to design in the CAD software application, the design may be fabricated using any known conductive pattern and/or touch sensor fabrication processes.

In the CAD software application, a representation of a conductive pattern may be designed for a given application or design. The representation of the conductive pattern may comprise a representation of a plurality of parallel conductive lines oriented in a first direction and a representation of a plurality of parallel conductive lines oriented in a second direction. The representation of the plurality of parallel conductive lines oriented in the first direction may be angled relative to the representation of the plurality of parallel conductive lines oriented in the second direction, thereby forming a mesh. In certain embodiments, a representation of a conductive line in the representation of the plurality of parallel conductive lines oriented in the first direction and the representation of the plurality of parallel conductive lines oriented in the second direction may have a line width less than approximately 5 micrometers. In other embodiments, a representation of a conductive line in the representation of the plurality of parallel conductive lines oriented in the first direction and the representation of the plurality of parallel conductive lines oriented in the second direction may have a line width in a range between approximately 5 micrometers and approximately 10 micrometers. In still other embodiments, a representation of a conductive line in the representation of the plurality of parallel conductive lines oriented in the first direction and the representation of the plurality of parallel conductive lines oriented in the second direction may have a line width greater than approximately 10 micrometers.

The representation of the conductive pattern may be partitioned into a plurality of channels by one or more channel breaks. In the CAD software application, the one or more channel breaks correspond to discontinuities, or breaks in electrical conductivity, that electrically isolate adjacent channels in the fabricated touch sensor. In step 1310, a plurality of channels in the representation of the conductive pattern may be identified. The channels may be row channels or column channels. In step 1320, for each channel identified, a representation of a channel connector is placed that connects to the channel outside a viewable area of the conductive pattern. The viewable area of the conductive pattern may include that portion of the conductive pattern that is intended to overlay a display device and transmit the underlying image of the display device to an end user. The viewable area of the conductive pattern typically does not include the channel connectors or those portions of the conductive pattern that are in direct contact with the channel connectors. A connection between the representations of the channel connectors and their respective channels correspond to electrical connectivity in the fabricated touch sensor. In certain embodiments, the representations of the channel connectors are substantially rectangular in shape. A length of the representations of the channel connectors may be less than or equal to a width of the corresponding channels they are connected to.

In step 1330, an interface location outside the viewable area of the conductive pattern is identified. The interface location may include a reserved area for a representation of a plurality of interface connectors that provide connectivity between the plurality of channels and a touch sensor controller via, for example, a cable in the fabricated touch sensor. The interface location may be dictated by the constraints of a particular application or design. In step 1340, for each channel, a representation of an interface connector may be placed within the interface location. In certain embodiments, the representations of the interface connectors may be substantially rectangular in shape.

In step 1350, for each channel, a representation of an interconnect route may be placed that connects its placed interface connector to its corresponding placed channel connector with at least a minimum interconnect route-to-interconnect route spacing. In step 1360, at least one interconnect route expands into available space within a bezel area as the interconnect route routes from the interface connector toward the channel connector while maintaining the at least minimum interconnect route-to-interconnect route spacing. In certain embodiments, the bezel area may be an area outside the viewable area of the conductive pattern that may be bounded in at least one direction by the interface connectors. In certain embodiments, the at least one interconnect route comprises a plurality of interconnect routes that expand into the available space evenly while maintaining the at least minimum interconnect route-to-interconnect route spacing for at least a portion of their respective routes from their respective interface connectors to their respective channel connectors. In one or more embodiments of the present invention, an additional resistance caused by excess length of the at least one interconnect route may be compensated for by additional area of the at least one interconnect route as it expands into the available space. The at least one interconnect may be non-linear, non-uniform, and/or unique in shape.

In certain embodiments, fill patterns may be used for any one or more of the interface connectors, interconnect routes, and/or channel connectors. In certain embodiments, a hatched fill pattern may be used. In other embodiments, a cross-hatched fill pattern may be used. In still other embodiments, a hatched polygon fill pattern may be used. In still other embodiments, a solid fill pattern may be used. One of ordinary skill in the art will recognize that other fill patterns, or combination of fill patterns, may be used in accordance with one or more embodiments of the present invention. Subsequent to design, the design of the conductive pattern and bezel circuit may be fabricated using any known fabrication process.

Advantages of one or more embodiments of the present invention may include one or more of the following:

In one or more embodiments of the present invention, a method of designing a bezel circuit compensates for variability in resistance, and/or flight times caused by different trace lengths among interconnect routes.

In one or more embodiments of the present invention, a method of designing a bezel circuit reduces or eliminates variability in resistance, and/or flight times and improves yield and/or reliability of the bezel circuit and the touch sensor in which it may be disposed.

In one or more embodiments of the present invention, a method of designing bezel circuit makes more effective use of the available space within a bezel area of the touch sensor and compensates for variability in resistance, and/or flight times among interconnect routes having different trace lengths. In conventional bezel circuits, longer interconnect conductive lines increase resistance, capacitance, and/or flight times compared to shorter ones. In one or more embodiments of the present invention, longer interconnect routes, that route to channel connectors disposed farther away from their respective interface connectors than shorter ones, expand into the available space within a bezel area and reduce the resistance and/or capacitance occasioned by their excess trace length. As a consequence, the interconnect routes provide more uniform resistance among the interconnect routes, resulting in more uniform flight times for signaling. Advantageously, the increased uniformity of flight times reduces or eliminates the need for counter measures, such as, for example, serpentine traces, other physical compensation, or compensation programmed into a touch sensor controller. Additionally, the overall reduced resistance can significantly improve the touch sensor signaling response therefore improving the touch sensor controller performance.

In one or more embodiments of the present invention, a method of designing a bezel circuit improves reliability. In conventional bezel circuits, longer interconnect conductive lines increase the probability of failure along the length of the interconnect conductive lines. Breaks, discontinuities, smears, shorts, and other failure modes along a length of any one interconnect conductive line may negatively impact connectivity between an interface connector and a channel connector and render the bezel circuit, and touch sensor in which it may be disposed, inoperable. In one or more embodiments of the present invention, because the interconnect routes expand into the available space of the bezel area, the excess trace width along the length reduces the likelihood of failure modes along a length of any one interconnect route. As a consequence, the yield and the reliability of the bezel circuit, and the touch sensor in which it may be disposed, may be improved.

In one or more embodiments of the present invention, a method of designing a bezel circuit may have at least one interconnect route that expands into available space within a bezel area as the interconnect route routes from an interface connector to a channel connector while maintaining at least a minimum interconnect route-to-interconnect route spacing.

In one or more embodiments of the present invention, a method of designing a bezel circuit may have a plurality of interconnect routes that expand into available space evenly while maintaining at least a minimum interconnect route-to-interconnect route spacing for a portion of their respective routes from their respective interface connectors to their respective channel connectors.

In one or more embodiments of the present invention, a method of designing a bezel circuit use available space within a bezel area that may be outside a viewable area of a conductive pattern and bounded in at least one direction by a plurality of interface connectors.

In one or more embodiments of the present invention, a method of designing a bezel circuit uses available space within a bezel area that may be constrained by the design of a conductive pattern, a predetermined location of the interface connectors, a breakout pattern, and/or the location of the interface connectors, or other touch screen constraints, such as the placement of an antenna, that may vary based on an application or design.

In one or more embodiments of the present invention, a method of designing a bezel circuit may use a substantial portion of the bezel area by allocating or reallocating available space as it becomes available along a route. The trace width of a given interconnect route may initially be dictated by the available space and the number of interconnect routes that route through that space. The density of interconnect routes may be higher near the interface connectors. However, as you progress away from the interconnect connectors, some interconnect routes route off to their respective channel connectors. When these interconnect routes route off to their respective channel connectors, more space in the bezel area becomes available. The newly available space may be reallocated among the remaining interconnect routes, equally or otherwise, that continue to route through that portion of the bezel area on the way to their respective channel connectors.

In one or more embodiments of the present invention, a method of designing a bezel circuit uses existing CAD software application(s).

In one or more embodiments of the present invention, a method of designing a bezel circuit is compatible with existing design flows and methodologies.

In one or more embodiments of the present invention, a method of designing a bezel circuit is compatible with existing fabrication processes, including flexographic printing processes configured to print a catalytic ink image of the bezel circuit on a substrate for subsequent electroless plating.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of designing a bezel circuit comprising:
identifying a plurality of channels in a representation of a conductive pattern;
for each channel, placing a representation of a channel connector that connects to the channel outside a viewable area of the conductive pattern;
identifying an interface location outside the viewable area of the conductive pattern;
for each channel, placing a representation of an interface connector within the interface location; and
for each channel, placing a representation of an interconnect route that connects its placed interface connector to its corresponding placed channel connector with at least a minimum interconnect route-to-interconnect route spacing,
wherein at least one interconnect route expands into available space within a bezel area as the interconnect route routes from the interface connector toward the channel connector while maintaining the at least minimum interconnect route-to-interconnect route spacing.

2. The method of claim 1, wherein the bezel area is an area outside the viewable area of the conductive pattern bounded in at least one direction by the interface connectors.

3. The method of claim 1, wherein the at least one interconnect route comprises a plurality of interconnect routes that expand into the available space evenly while maintaining the at least minimum interconnect route-to-interconnect route spacing for a portion of their respective routes from their respective interface connectors to their respective channel connectors.

4. The method of claim 1, wherein an additional resistance caused by excess length of the at least one interconnect route is compensated for by additional area of the at least one interconnect route as it expands into the available space.

5. The method of claim 1, wherein the at least one interconnect route is non-linear.

6. The method of claim 1, where the at least one interconnect route is non-uniform.

7. The method of claim 1, wherein a fill pattern of the at least one interconnect comprises a random mesh pattern.

8. The method of claim 1, wherein a fill pattern of the at least one interconnect comprises a cross-hatched pattern.

9. The method of claim 1, wherein a fill pattern of the at least one interconnect comprises a hatched polygon pattern.

10. The method of claim 1, wherein a fill pattern of the at least one interconnect comprises a solid fill pattern.

11. The method of claim 1, wherein the representation of the conductive pattern comprises a representation of a plurality of parallel conductive lines oriented in a first direction and a representation of a plurality of parallel conductive lines oriented in a second direction.

12. The method of claim 11, wherein the representation of the plurality of parallel conductive lines oriented in the first direction are angled relative to the representation of the plurality of parallel conductive lines oriented in the second direction forming a mesh.

13. The method of claim 11, wherein a representation of a conductive line in the representation of the plurality of parallel conductive lines oriented in the first direction and the representation of the plurality of parallel lines oriented in the second direction have a line width less than approximately 5 micrometers.

14. The method of claim 11, wherein a representation of a conductive line in the representation of the plurality of parallel conductive lines oriented in the first direction and the representation of the plurality of parallel lines oriented in the second direction have a line width in a range between approximately 5 micrometers and approximately 10 micrometers.

15. The method of claim 1, wherein each channel is isolated from the other channels by one or more channel breaks.

16. The method of claim 15, wherein the one or more channel breaks correspond to discontinuities that electrically isolate adjacent channels in the fabricated touch sensor.

17. The method of claim 1, wherein the connection between the representations of the channel connectors and their respective channels correspond to electrical connectivity in the fabricated touch sensor.

18. The method of claim 1, wherein the representations of the channel connectors are substantially rectangular in shape.

19. The method of claim 1, wherein a length of the representations of the channel connectors is less than or equal to a width of the corresponding channels they are connected to.

20. The method of claim 1, wherein the representation of the interface connector is substantially rectangular.
